(19) United States
(12) Patent Application Publication
(10) Pub. No.: US 2008/0182442 A1
(43) Pub. Date: Jul. 31, 2008

(54) Data Port for a Mobile Device

(76) Inventors: JaeHo Choi, Whitestone, NY (US); Carl Thelemann, East Islip, NY (US)

Correspondence Address: FAY KAPLUN & MARCIN, LLP, 150 BROADWAY, SUITE 702, NEW YORK, NY, 10038, US

(21) Appl. No.: 11/669,618

(22) Filed: Jan. 31, 2007

(51) Int. Cl. H01R 13/00

(52) U.S. Cl. 439/166

(57) ABSTRACT

A mobile device may include (a) a multi-contact connector configured to couple to a further connector of one of a plurality of auxiliary devices. The further connector has a preset configuration of contact points for each type of the auxiliary devices. The mobile device may also include (b) a detection module which determines a type of the one of the plurality of auxiliary devices as a function of the preset configuration of contact points.

### BACKGROUND

Mobile terminals may be used in a wide variety of environments. In certain environments, it is advantageous to wear the mobile terminal to free up a user's hands. The terminal may be worn in various locations such as a wrist, a belt, etc. In addition, the mobile terminal may be equipped with further hardware (auxiliary device) that plugs into the mobile terminal. For example, a headset may be worn for voice applications. In another example, a scanner may be used. Further hardware such as headsets may incorporate wireless technologies and would not require hard wiring. However, other further hardware and sometimes headsets are hard-wired into the mobile terminal. The connections required to link the further hardware into the mobile terminal may also differ. When incorporating more than one further hardware, the wiring may create an awkward set up that may hinder proper usage of the mobile terminal.

### SUMMARY OF THE INVENTION

The present invention relates to a mobile device. The mobile device may include (a) a multi-contact connector configured to couple to a further connector of one of a plurality of auxiliary devices. The further connector has a preset configuration of contact points for each type of the auxiliary devices. The mobile device may also include (b) a detection module which determines a type of the one of the plurality of auxiliary devices as a function of the preset configuration of contact points

### DESCRIPTION OF THE DRAWINGS

FIG. 1 shows an exploded view of a back side of a mobile terminal assembly according to an exemplary embodiment of the present invention.

FIG. 2 shows an exploded view of a front side of the mobile terminal assembly of FIG. 1.

FIG. 3 shows an assembled view of the back side of the mobile terminal assembly of FIG. 1.

FIG. 4a shows a perspective view of a first connector that is insertable into the mobile terminal of FIG. 1.

FIG. 4b shows a perspective view of a second connector that is insertable into the mobile terminal of FIG. 1.

FIG. 4c shows a first perspective view of the port of the mobile terminal of FIG. 1.

FIG. 5a shows a first cross sectional view of the connector of FIG. 4b that contacts the port of FIG. 4c.

FIG. 5b shows a second cross sectional view of the connector of FIG. 4b that contacts the port of FIG. 4c.

FIG. 5c shows a third cross sectional view of the connector of FIG. 4b that contacts the port of FIG. 4c.

FIG. 5d shows a cross sectional view of the connector of FIG. 4a that contacts the port of FIG. 4c.

FIG. 5e shows a cross sectional view of the connector of FIG. 4a that inserts into the port of FIG. 4c.

FIG. 5f shows a cross sectional view of the connector of FIG. 4b that inserts into the port of FIG. 4c.

FIG. 6 shows a perspective view of a third connector that is insertable into the mobile terminal of FIG. 1.

FIG. 7a shows a perspective view of a first plug for the connector of FIG. 1.

FIG. 7b shows a perspective view of a second plug for the connector of FIG. 1.

FIG. 8a shows a second perspective view of the port of the mobile terminal of FIG. 1.

FIG. 8b shows a third perspective view of the port of the mobile terminal of FIG. 1.

FIG. 8c shows a fourth perspective view of the port of the mobile terminal of FIG. 1.

FIG. 9a shows a second pin configuration according to an exemplary embodiment of the present invention.

FIG. 9b shows a third pin configuration according to an exemplary embodiment of the present invention.

FIG. 9c shows a fourth pin configuration according to an exemplary embodiment of the present invention.

FIG. 9d shows a fifth pin configuration according to an exemplary embodiment of the present invention.

FIG. 9e shows a sixth pin configuration according to an exemplary embodiment of the present invention.

### DETAILED DESCRIPTION

The present invention may be further understood with reference to the following description and the appended drawings, wherein like elements are referred to with the same reference numerals. The exemplary embodiments of the present invention show a mobile terminal with dual ports to receive hardware that is independent of the type of hardware. The dual ports and hardware independence will be discussed in detail below.

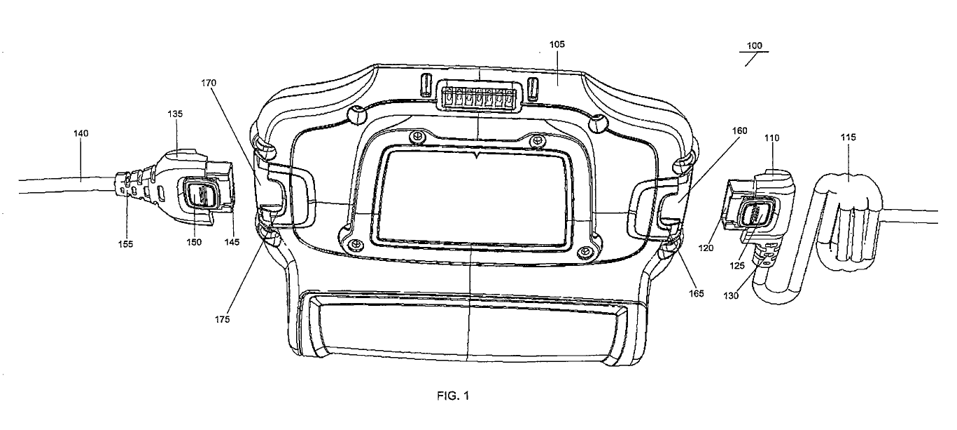

FIG. 1 shows an exploded view of a back side of a mobile terminal assembly 100 according to an exemplary embodiment of the present invention. The mobile terminal assembly 100 includes a mobile terminal 105, an audio device (AD) connector 110, and a scanner connector 135. It should be noted that the use of the AD connector 110 and the scanner connector 135 is only exemplary and the connectors may be for different types of further components such as RFID readers, disk drives, input devices (e.g., mouse, portable keyboard), etc.

In the exemplary embodiment, the mobile terminal 105 may be wearable and capable of connecting further hardware devices to increase the functionality of the mobile terminal 105. The mobile terminal 105 may be worn on, for example, a user's wrist or belt. To attach the mobile terminal, a conventional wearing mechanism may be part of the mobile terminal. To facilitate the connection of further hardware, the mobile terminal 105 includes ports 160, 170. The ports 160, 170 will be discussed in more detail below. It should be noted that the use of two ports 160, 170 is only exemplary and the mobile terminal 105 may include further ports to accommodate more than two further hardware devices. The further hardware devices may be, for example, a scanner, an audio input/output device, a disk drive, RFID reader, etc.

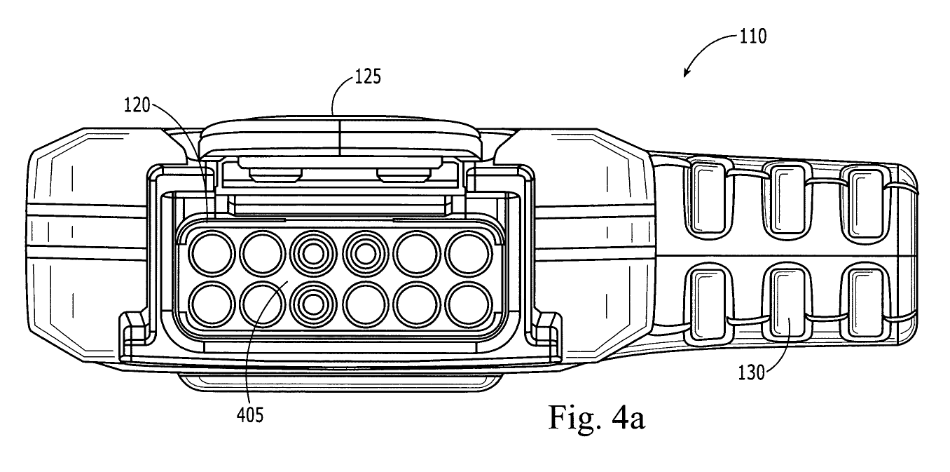

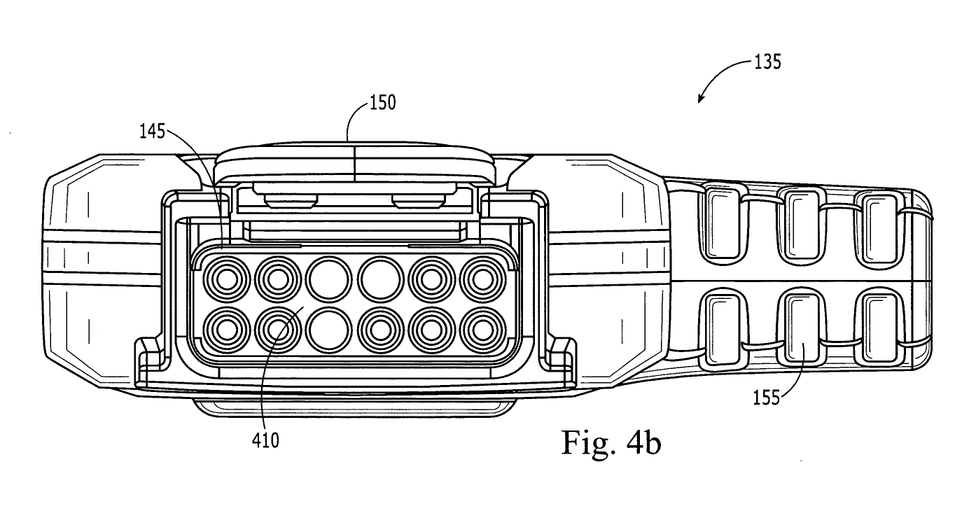

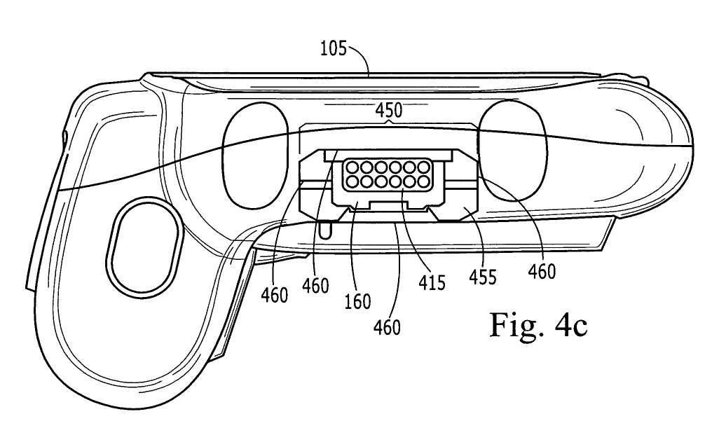

In the exemplary embodiment, the ports 160, 170 are located on opposing sides of the mobile terminal 105. Specifically, in the exemplary embodiment, the port 160 is located on a right side of the mobile terminal 105 while the port 170 is located on a left side of the mobile terminal 105. It should be noted that the use of the right and left sides is only exemplary. For example, the ports 160, 170 may be located on a top and bottom side of the mobile terminal 105. In another example, the ports 160, 170 may both be located on the top side of the mobile terminal 105. Those skilled in the art will understand that the location of the ports 160, 170 may depend on the position/orientation of the mobile terminal 105 when worn, the further hardware device that connects to the mobile terminal 105, the location of the further hardware device in relation to the mobile terminal 105, etc. The functionality of the ports 160, 170 will be discussed in more detail below with reference to FIGS. 4a-c.

The audio device (AD) connector 110 is a unit that connects an audio device (not shown) with the mobile terminal 105. As discussed above, the audio device may be an audio input/output device such as a headset with microphone. The AD connector 110 includes an AD cord 115, an AD plug 120, an AD locking mechanism 125, and an AD break away point 130. The scanner connector 135 is a unit that connects a scanning device (not shown) with the mobile terminal 105. The scanning device may be, for example, a finger scanner, an optical scanner, a bar code scanner, etc. The scanner connector 135 includes a scanner cord 140, a scanner plug 145, a scanner locking mechanism 150, and a scanner break away point 155.

In the exemplary embodiment, the AD cord 115 and the scanner cord 140 may be a set of wires, fiber optics, etc. encased in a protective sheath such as rubber. The AD cord 115 may exhibit a spring feature that retracts the AD cord 115 when the audio device is not in use. Those skilled in the art will understand that the spring feature keeps the AD cord 115 taut when in use to prevent the AD cord 115 from hanging loosely and, for example, being inadvertently caught on another object. However, it should be noted that the use of the spring feature is only exemplary and the AD cord 115 may be a cord with no spring feature similar to the scanner cord 140. Those skilled in the art will also understand the use for the spring feature because the audio device is likely to be further away from the mobile terminal 105 than the scanning device. For example, the mobile terminal 105 may be worn on a wrist. When worn on the wrist, a finger scanner is relatively close (about the length of a hand) to the mobile terminal 105 while the audio device is relatively far (about the length of an arm, shoulder, and neck). Thus, in the exemplary embodiment, the AD cord 115 exhibits a spring feature while the scanner cord 140 does not include one. However, it should be noted that the scanner cord 140 may also exhibit the spring feature.

In the exemplary embodiment, the AD plug 120 and the scanner plug 145 are units of the AD connector 110 and the scanner connector 135, respectively, that are inserted in the mobile terminal 105 at the ports 160, 170, respectively. The AD plug 120 and the scanner plug 145 will be discussed in more detail below with reference to FIGS. 4a-c.

The AD locking mechanism 125 and the scanner locking mechanism 150 are units of the AD connector 110 and the scanner connector 135, respectively, that prevents inadvertent disconnection of the respective hardware unit. The AD locking mechanism 125 and the scanner connector 150 may be, for example, a button lock. The button lock is located on a back side of the AD connector 110 and the scanner connector 135. The button lock may be pushed to release, for example, a hook from a loop located on the mobile terminal 105. For example, the mobile terminal 105 may have a corresponding locking mechanism 165, 175 in a substantially close location to the port 160, 170, respectively. The hook portion of the button lock may be angled so a user is not required to push the button lock when inserting the AD connector 110 and/or the scanner connector 135 in the ports 160, 170, respectively. It should be noted that the use of the button lock is only exemplary and the AD connector 110 and the scanner connector 135 may use a different locking mechanism (e.g., magnets, straps, etc.). It should also be noted that the AD connector 110 and the scanner connector 135 may not include a locking mechanism.

The AD connector 110 and the scanner connector 135 may also include break away points 130, 155, respectively. The break away point 130 may be located where the AD cord 115 and the main body of the AD connector 110 meet. The break away point 155 may be located where the scanner cord 140 and the main body of the scanner connector 135 meet. The break away points 130, 155 serve as a safety precaution to prevent any harm to a user if inadvertent force is applied to the AD cord 115 and/or the scanner cord 140. In addition, the break away points 130, 155 allows the relatively cheaper further hardware connection to break off prior to any damage to the mobile terminal 105. The user may then exchange or repair only the peripherals (e.g., further hardware, AD connector 110, scanner connector 135, etc.).

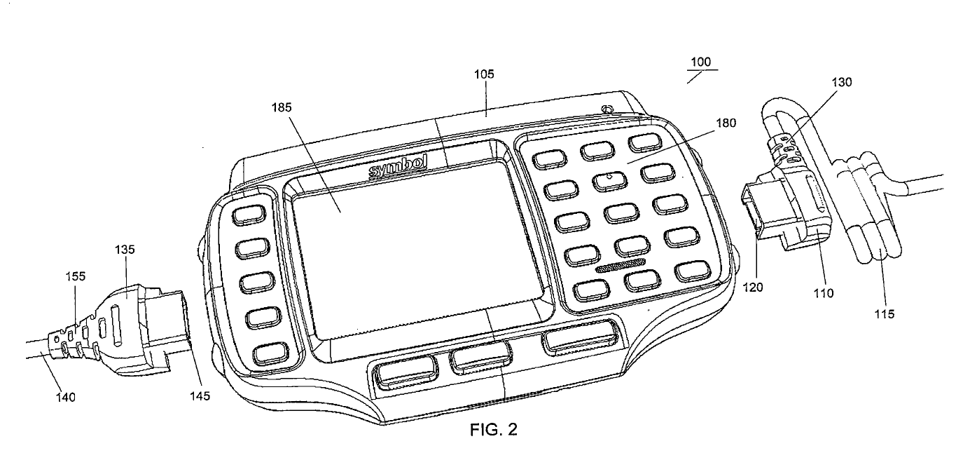

FIG. 2 shows an exploded view of a front side of the mobile terminal assembly 100 of FIG. 1. The front side of the mobile terminal assembly 100 of FIG. 1 shows the front sides of the mobile terminal 105; the AD connector 110 including the AD cord 115, the AD plug 120, and the AD break away point 130; and the front sides of the scanner connector 135 including the scanner cord 140, the scanner plug 145, and the scanner break away point 155. The front side of the mobile terminal 105 also includes an input panel 180 and a display 185. The input panel 180 and the display 185 may be conventional mobile terminal components. The input panel 180 and the display 185 may also include the necessary functionality to allow use of the further hardware (e.g., audio device, scanner, etc.) that connects to the mobile terminal 105. The input panel 180 and the display 185 may also be connected to circuitry that automatically adjusts to the type of further hardware upon connection. Those skilled in the art will understand that the circuitry may also be connected to the ports 160, 170 to recognize that further hardware has been connected.

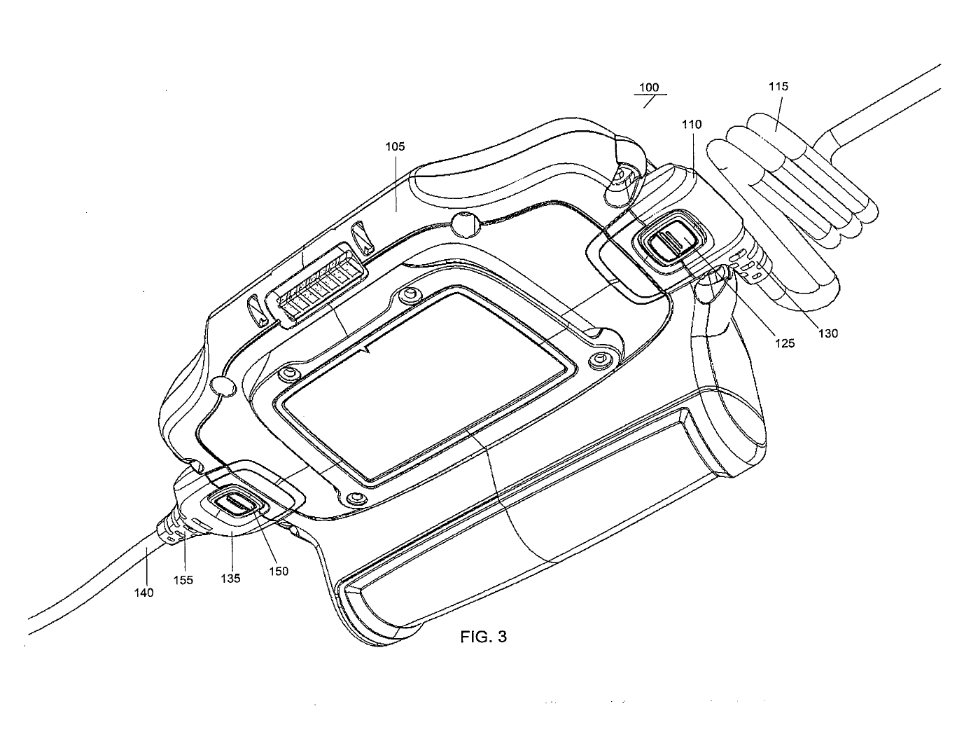

FIG. 3 shows an assembled view of the back side of the mobile terminal assembly 100 of FIG. 1. The assembled view of the mobile terminal assembly 100 of FIG. 1 shows the mobile terminal 105 with the AD connector 110 and the scanner connector 135 connected to the respective ports (i.e., port 160 for AD connector 110; port 170 for scanner connector 135). In the exemplary embodiments, the AD locking mechanism 125 and the scanner locking mechanism 150 have been engaged.

FIG. 4a shows a perspective view of the AD connector 110 that is insertable into the port 160 of the mobile terminal 105. FIG. 4a shows the button lock 125 and the AD break away point 130 of the AD connector 110. In the exemplary embodiment, the AD plug 120 is shown with pins 405 within the housing of the AD plug 120. The pins 405 include three pins that are coupled to complimentary pins in the female ports within the port 160. The female ports of the port 160 will be discussed below with reference to FIG. 4c. It should be noted that the use of pins to create the connection between the further hardware device (e.g., audio device) and the mobile terminal 105 is only exemplary. Those skilled in the art will understand that there are other means to establish an electrical connection between a mobile terminal and a further hardware. It should also be noted that the use of three pins is only exemplary and there may be more or less than three pins.

FIG. 4b shows a perspective view of the scanner connector 135 that is insertable into the port 170 of the mobile terminal 105. FIG. 4b shows the button lock 150 and the scanner break away point 155 of the scanner connector 135. In the exemplary embodiment, the scanner plug 145 is shown with pins 410 within the housing of the scanner plug 145. The pins 410 include nine pins that are coupled to complimentary pins in the female ports within the port 170. The female ports of the port 170 will be discussed below with reference to FIG. 4c. It should again be noted that the use of pins to create the connection between the further hardware (e.g., audio device) and the mobile terminal 105 is only exemplary. Those skilled in the art will understand that there are other means to establish an electrical connection between a mobile terminal and a further hardware. It should again also be noted that the use of nine pins is only exemplary and there may be more or less than nine pins. Furthermore, the complimentary pins for the pins 405, 410 may be, for example, electrical contact points, female pins, etc.

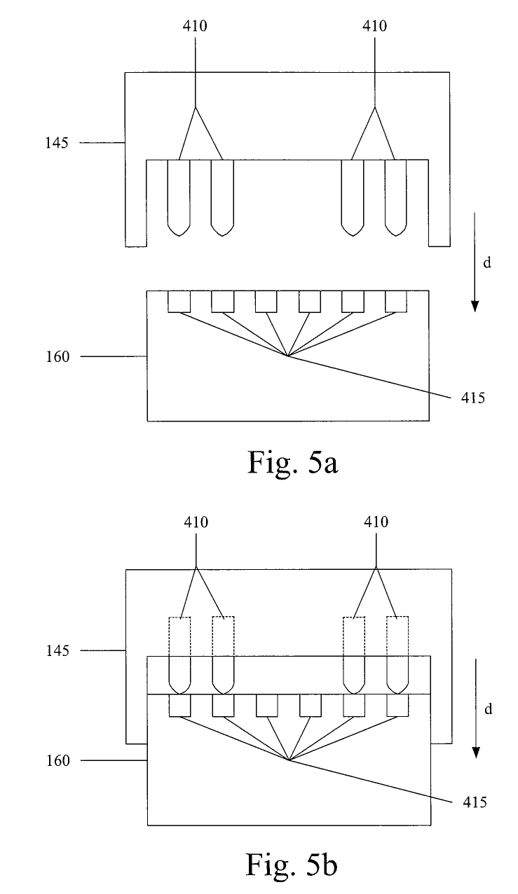

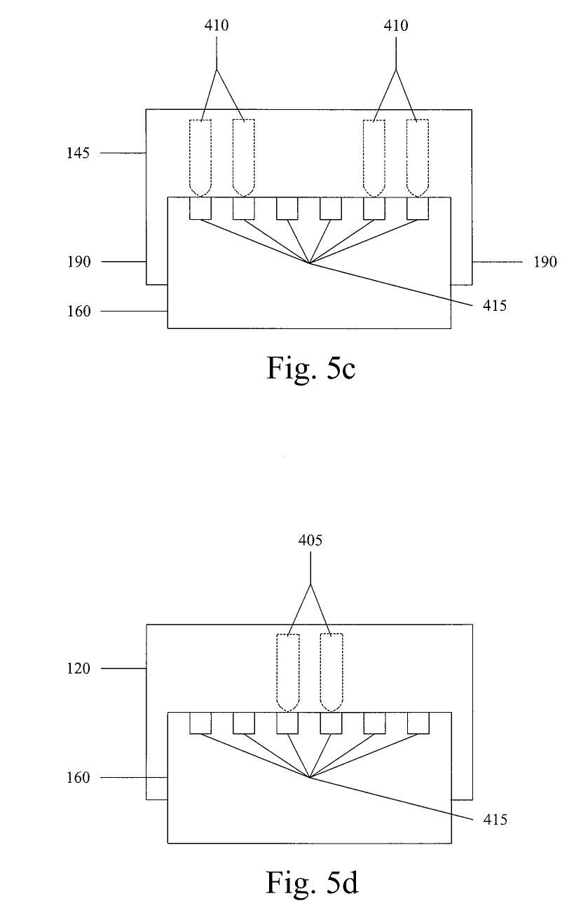

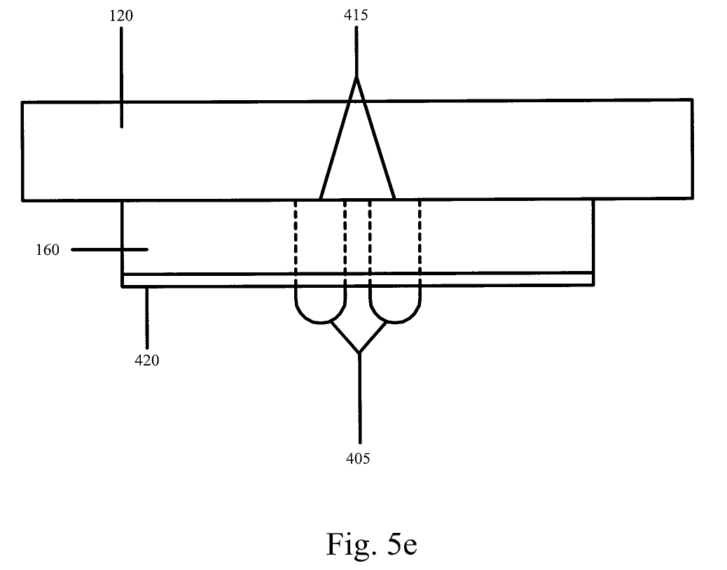

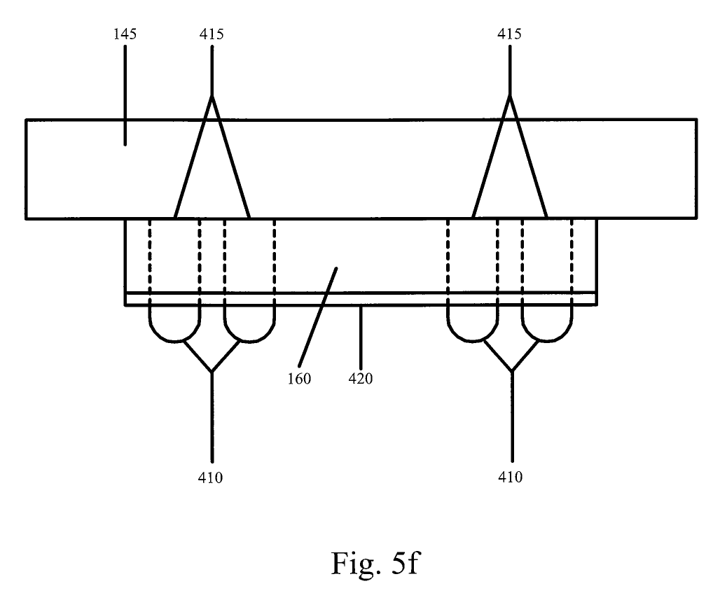

FIGS. 4a-b also illustrate that the pins 405 and the pins 410 are complementary with each other. That is, the three pins of the pins 405 correspond to the empty pin slots among the nine pins of the pins 410. Specifically, the pins 405, 410 are arranged to contain two rows, each with 6 positions. Assuming the top left position is position 1 and the bottom left position is position 7, the pins 405 contain a pin in positions 3, 4, and 9. The pins 410 contain a pin in positions 1, 2, 5, 6, 7, 8, 10, 11, and 12. Using this configuration, a common port (e.g., port 160) with twelve pins may be used to receive the AD connector 110 or the scanner connector 135. The port 160 that receives the pins 405 (i.e., AD connector 110) will recognize that when the three pins of the pins 405 are coupled to the complimentary pin holes, the audio device has been connected. In a similar manner, the port 170 that receives the pins 410 (i.e., scanner connector 135) will recognize that when the nine pins of the pins 410 are coupled to the complimentary pins, the scanner has been connected. Because the recognition of the further hardware device is done using the configuration of the pins (e.g., pins 405, 410), those skilled in the art will understand that the AD connector 110 may be insertable into the port 170 while the scanner connector 135 may be insertable into the port 160 and the corresponding hardware device will be recognized regardless of the port into which it is connected. The method in which the further component is recognized will be discussed in more detail below with reference to FIGS. 5a-f. It should be noted that the pins 405 and the pins 410 being complimentary are only exemplary and used as a simplified example. Those skilled in the art will understand that with the mobile terminal 100 having the capability of receiving more than two further hardware, different pin configurations will exist.

FIG. 4c shows an exemplary embodiment of the port 160 of the mobile terminal 105. It should be noted that FIG. 4c also represents an exemplary embodiment of the port 170 and that the description herewith concerns the port 170 as well. The port 160 is shown with complimentary pins 415. It should again be noted that the complimentary pins 415 may be, for example, electrical contact points, female pins, etc. The complimentary pins 415 contain the corresponding twelve pins for the connectors 110, 135 (e.g., electrical contact points for spring pins, female pins for insertable male pins, etc.). For example, a pin located in position 1 would correspond to the top left corresponding pin of the complimentary pins 415. As discussed above, the design of the complimentary pins 415 is to accommodate any number of pins on the connector of the further hardware that do not exceed twelve and maintain a like orientation. Thus, in addition to accommodating the AD connector 110 and the scanner connector 135, the complimentary pins 415 may also accommodate, for example, a disk drive. The disk drive may contain six pins with three pins in a top row and three pins in a bottom row. When the six pins of the disk drive are coupled to the complimentary pins 415, the port (e.g., port 160, 170) or the processor of the mobile terminal 105 that is connected to the port recognizes that a disk drive has been connected.

FIG. 4c also shows that the housing of the mobile terminal 105 may include a recess 450 in which the port 160 is located. The recess 450 includes a back wall 455 and sidewalls 460. The recess 450 has a generally rectangular shape that is slightly larger than the outline of the port 160. However, those skilled in the art will understand that the recess 450 may take on any shape as will be described in greater detail below. In this example, the port 160 extends out from the back wall 455 and does not contact three (3) of the four (4) sidewalls 460. However, in other embodiments, the port 160 may contact zero, one, two, or three of the sidewalls 460. In this exemplary embodiment, the recess 450 receives a portion of the connector (e.g., scanner connector 135) that is attached to the port 160. For example, a body of the scanner connector 135 may be larger than the port 160 and also shaped to fit snugly into the recess 450. Thus, when the scanner connector 135 is connected to the port 160, the portion of the scanner connector 135 that fits into the recess 450 may provide additional mechanical support for the connection so that the scanner connector 135 does not dislodge from the port 160 and that the connection does not become unstable with use (e.g., through wear or mechanical stress). Thus, as described above, the recess 450 may take any shape that is complimentary to the shape of the connector(s) that are to be connected to the port 160.

FIGS. 5a-d illustrate embodiments relating to static electrical contact points that couple with, for example, spring pins. That is, the pins 405, 410 are spring pins that retract into the connector as the connector is inserted into the port. Specifically, FIG. 5a shows a first cross sectional view of the scanner plug 145 of FIG. 4b that contacts the port 160 of FIG. 4c. The pins 410 of the scanner plug 145 are located in a position where no contact is made with the electrical contact points 415 of the port 160. The scanner plug 145 is being moved in the direction d toward the port 160.

FIG. 5b shows a second cross sectional view of the scanner plug 145 of FIG. 4b that contacts the port 160 of FIG. 4c. Specifically, the pins 410 of the scanner plug 145 are located in a position where contact has been established with the electrical contact points 415 of the port 160. The scanner plug 145 has moved in the direction d toward the port 160 so that a portion of the pins 410 has been retracted into the body of the scanner plug 145.

FIG. 5c shows a third cross sectional view of the scanner plug 145 of FIG. 4b that contacts the port 160 of FIG. 4c. Specifically, the pins 410 of the scanner plug 145 are located in a position where contact has been established with the electrical contact points 415 of the port 160. The scanner plug has moved toward the port 160 so that the entire portion of the pins 410 has been retracted into the body of the scanner plug 145. Furthermore, this embodiment illustrates when, for example, the locking mechanism described above with reference to FIG. 2 has been engaged. In addition, this view also shows a portion 190 of the scanner plug 145 that will extend into the recess 450 of the housing of the mobile terminal 105 as described with reference to FIG. 4c.

FIG. 5d shows a cross sectional view of the AD plug 120 of FIG. 4a that contacts the port 160 of FIG. 4c. Specifically, the pins 405 of the AD plug 120 are located in a position where contact has been established with the electrical contact points 415 of the port 160. The AD plug 120 may have initially been in a position similar to the scanner plug 145 discussed above with reference to FIG. 5a. The AD plug 120 may have moved toward the port 160 in a manner similar to the scanner plug 145 discussed above with reference to FIG. 5b to result in the positioning illustrated.

It should be noted that because the pins 405, 410 of FIGS. 5a-d are spring pins, when the connector is removed from the port, the pins will extend out of the body of the connector, thereby returning to the position illustrated in FIG. 5a. Furthermore, a determination of which pin positions have established a circuit or connection may indicate the configuration of pins. This determination may then alert, for example, a processor which subsequently determines the type of further hardware device.

FIGS. 5e-f illustrate embodiments when the pins 405, 410 are solid, immovable pins and the complimentary pin 415 are corresponding pin holes that receive the pins. FIG. 5e shows a cross sectional view of the AD plug 120 of FIG. 4a that is inserted into the port 160 of FIG. 4c. Specifically, the top row of pins 405 of the AD plug 120 is shown passing through the complimentary pins 415 of the port 160. The pins 405 also pass through a pin sensor 420. The pin sensor 420 detects the configuration of the pins for the plug of the further component. For example, the AD plug 120 has pins on positions 3, 4, and 9. The pin sensor 420 detects this pin configuration and determines that the further hardware device that has been plugged into the mobile terminal 105 is an audio device. It should be noted that the pin sensor 420 disposed within the mobile terminal 105 (beyond the port 160) is only exemplary. The pin sensor 420 may be disposed, for example, on the periphery of the mobile terminal (e.g., between the AD plug 120 and the port 160) or within the housing of the port 160.

FIG. 5f shows a cross sectional view of the scanner plug 145 of FIG. 4b that is inserted into the port 160 of FIG. 4c. Specifically, the top row of pins 410 of the scanner plug 145 is shown passing through the complimentary pins 415 of the port 160. It should be noted that the scanner plug 145 may be inserted into the port 170. However, the identical configuration for ports 160, 170 allow the scanner plug 145 to also fit into the port 160 in the same manner as the AD plug 120 illustrated in FIG. 5e. The pins 410 also pass through the pin sensor 420. The pin sensor 420 detects the configuration of the pins for the plug of the further component. For example, the scanner plug 145 has pins on positions 1, 2, 5, 6, 7, 8, 10, 11, and 12. The pin sensor 420 detects this pin configuration and determines that the further component that has been plugged into the mobile terminal 105 is a scanner.

It should be noted that the use of a pin sensor 420 is only exemplary. Those skilled in the art will understand that there are other methods of detecting a configuration of pins. For example, when the pins are inserted, the pins may push a spring device that provides an electrical contact, thereby creating a connection. In another example, the pin configuration may be detected using optics where, for example, a pin blocks a light's path thereby alerting its presence. In yet another example, the pin lengths may vary. Using a pin sensor that extends the length of the body of the port 160, the varying lengths may determine the further component. Using varying lengths allows devices to exhibit an identical pin configuration but with varying lengths of pins. In another example, the processor (or other hardware device) of the mobile terminal 105 may be able to test the conductivity of the different positions of the port 160 and determine which positions have been connected to the connector of the further hardware device, thereby detecting the configuration of the pins (as is the case with the exemplary embodiments described above with reference to FIGS. 5a-d).

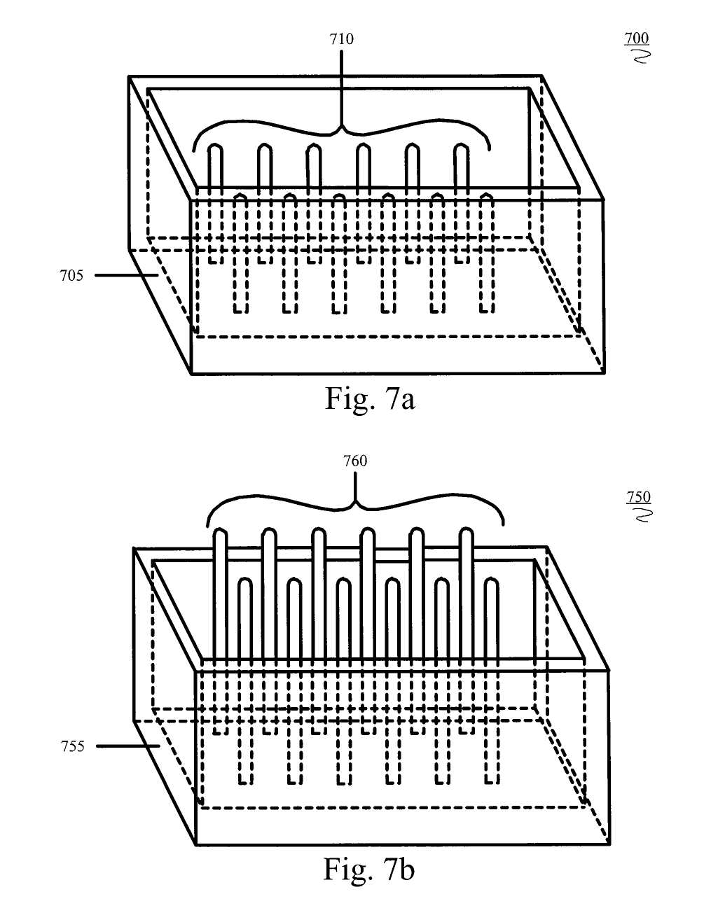

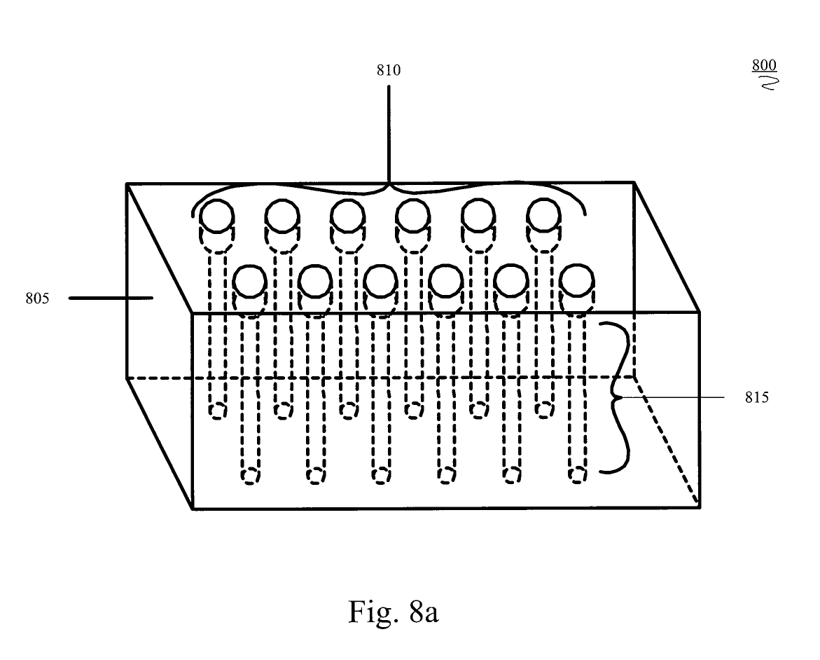

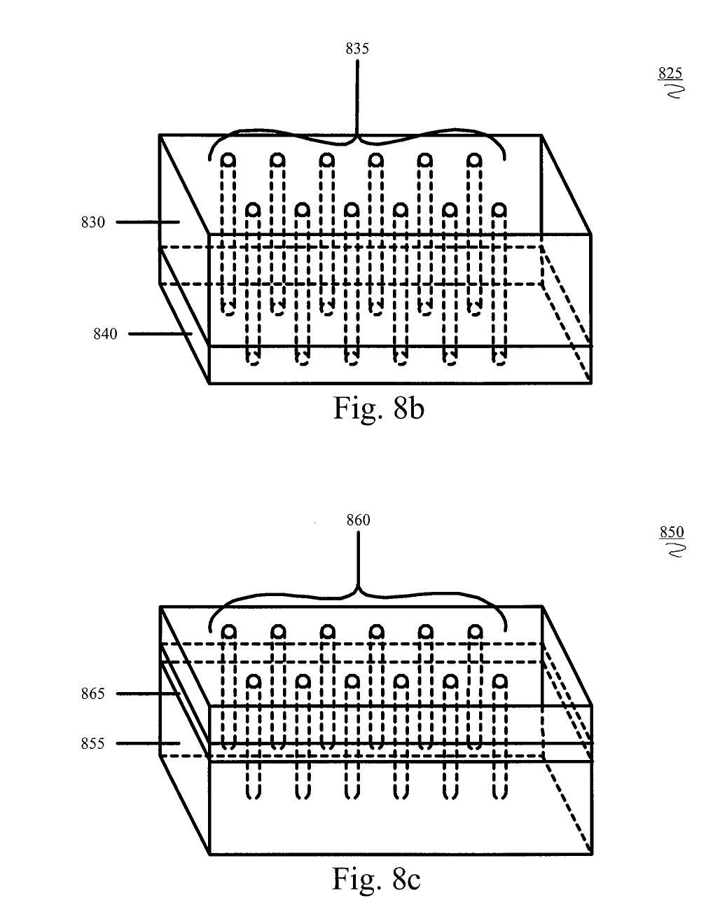

It should also be noted that the pins extending beyond the port 160 and the pin sensor 420 is only exemplary. Those skilled in the art will understand that the pins may extend beyond the port (as illustrated), may extend the length of the port, or may extend a portion of the length of the port. The different potential lengths of the pins will be discussed in more detail below with reference to FIGS. 7-8.

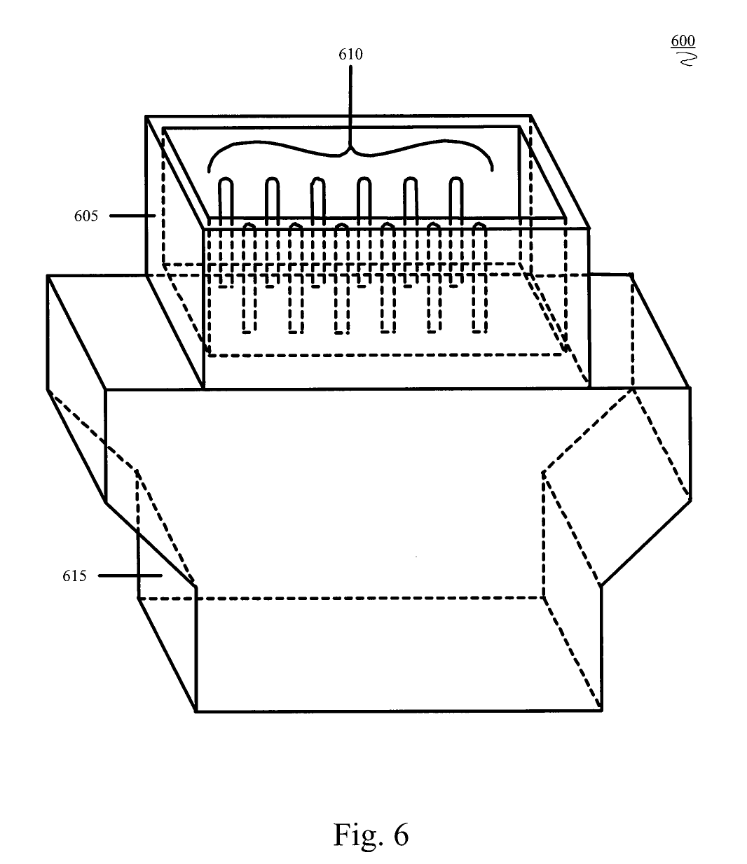

FIG. 6 shows a perspective view of a third connector 600 that is insertable into the mobile terminal 105 of FIG. 1. Specifically, the third connector 600 may represent a further connector for attaching, for example, an RFID reader to the mobile terminal 105. It should be noted that the third connector 600 may also represent either the AD connector 110 or the scanner connector 135. Similar to the design illustrated for the AD connector 110 and the scanner connector 135 in FIG. 1, the third connector 600 includes a pin housing 605, pins 610, and an electrical housing 615. The pins 610 may be, for example, spring pins (as described with reference to FIGS. 5a-d) or solid pins (as described with reference to FIGS. 5e-f).

The pin housing 605 provides a protective casing for the pins 610 while the electrical housing 615 provides a protective casing for the wiring that is coupled to the pins 610. The electrical housing 615 may also provide a retraction space for the pins 610, particularly when the pins 610 are spring pins. The pin housing 605 may be manufactured using a rigid plastic to provide a sturdier support. However, it should be noted that the use of rigid plastic is only exemplary and the pin housing 605 may be manufactured using other materials such as rubber, polymers, etc. The pin housing 605 is illustrated as a hollowed out, rectangular solid. However, the pin housing 605 may be manufactured with other features such as rounded corners, tapering sides, etc. In addition, the pin housing includes a solid bottom where the pins 610 are held. However, the solid bottom may be absent so that the pins 610 may protrude directly out of the electronic housing 615.

The pin housing 605 may be designed with various specifications. For example, the walls may exhibit a width necessary to prevent inadvertent mishandling of the pins 610. The width range may vary depending on the substance used to manufacture the pin housing 605. The pin housing 605 may also be designed to house the pins 610 in several different manners. For example, the pins 610 may be housed snugly in the pin housing 605. A snug fit would leave little distance between the walls of the pin housing 605 and the pins 610. Such an embodiment increases the protection provided to the pins 610. In another example, the pins 610 may be housed loosely in the pin housing 605. A loose fit would leave a sufficient distance for a user to manipulate the pins when, for example, a pin bends and is no longer aligned with the corresponding pin hole of a port on the mobile terminal. It should be noted that the manner in which the pin housing 605 houses the pins 610 may depend on the orientation (e.g., pin to pin distance), configuration (e.g., arrangement, number of pins), etc.

It should be noted that the use of the pin housing 605 is only exemplary. The present invention may utilize a connector that does not have the pin housing 605. In an embodiment where the pin housing 605 is absent, the pins 610 may be manufactured of sturdier materials or be manufactured with a larger cross-sectional width.

In the exemplary embodiment, for illustration purposes that correspond to the above description, the pins 610 include twelve pins. However, as discussed above, the pins 610 may exhibit various configurations. Since a zero pin configuration does not exist, the maximum number of configurations may follow the basic formula of 2^{N}−1, where N is the number of complimentary pins. For example, when there are twelve pin holes in a port, the number of configurations may be up to 4,095 (i.e., 2¹²−1); when there are fourteen pin holes in a port, the number of configurations may be up to 16,383 (i.e., 2¹⁴−1); etc.

The overall layout of the pins 610 shows two parallel rows of pins, each row containing at most six pins. The pins are aligned so that the first column of pins (six total) (e.g., first pin of the first row and the first pin of the second row) is disposed perpendicularly to either row. However, the use of two rows of parallel pins aligned perpendicularly (also illustrated in FIGS. 4a-b, 5e-b) is only exemplary as described by the following examples.

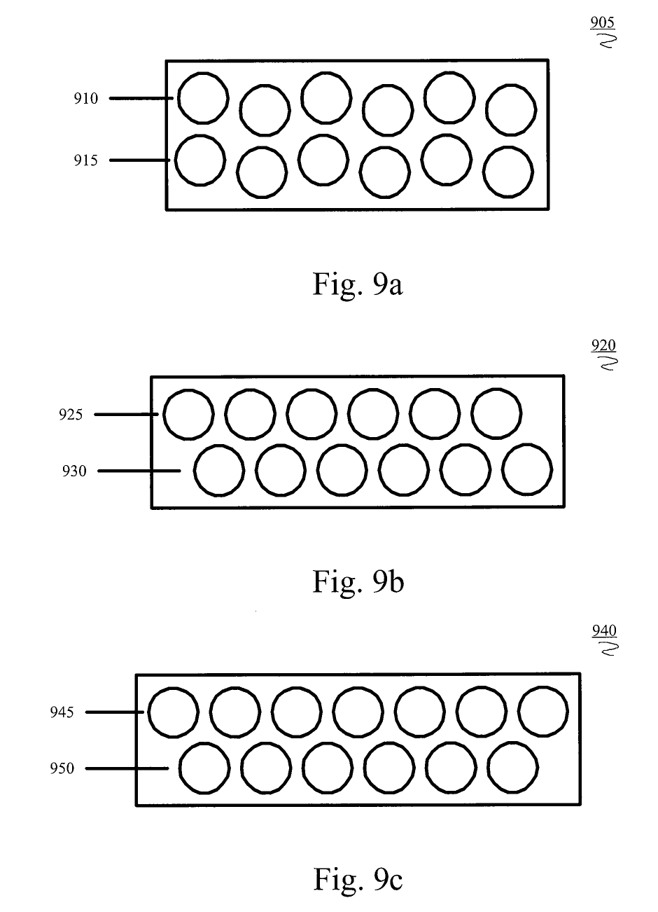

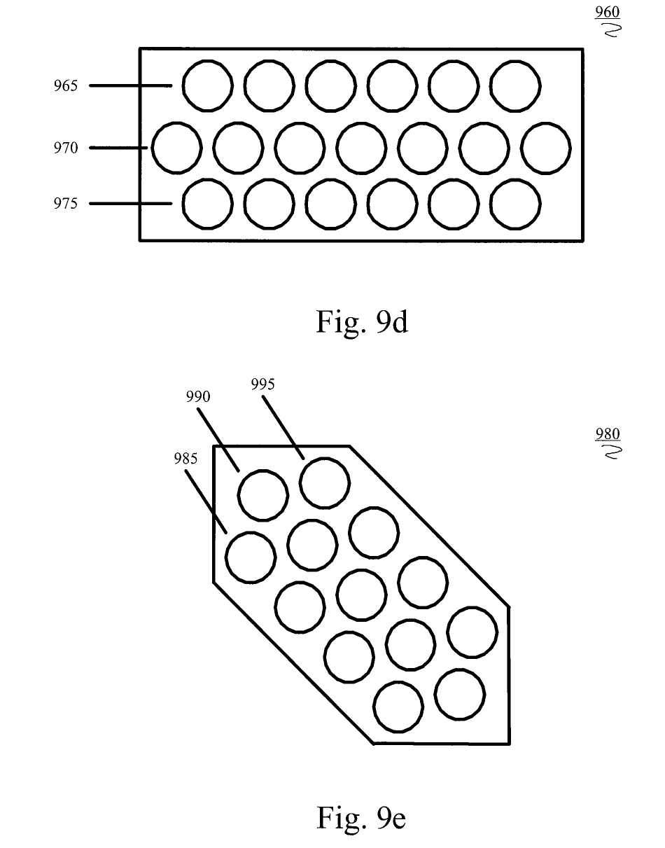

In a first example, FIG. 9a shows a second pin configuration 905 according to an exemplary embodiment of the present invention. The configuration 905 also includes two rows 910, 915. However, the two rows 910, 915 are not linear. Specifically, the rows 910, 915 exhibit a staggered pattern.

In a second example, FIG. 9b shows a third pin configuration 920 according to an exemplary embodiment of the present invention. The configuration 920 also includes two rows 925, 930. Similar to the configuration illustrated in FIGS. 4a-b, 5e-b, and 6, the two rows 925, 930 are linear. However, the two rows 925, 930 are not aligned perpendicularly. Specifically, the two rows 925, 930 are aligned at an angle so that any given column is positioned at a non-right angle with either row. For example, the first pin in row 925 and the first pin in row 930 are disposed on a line that is angled, for example, 45°. FIG. 9b shows the row 925 closer to the left side of the configuration 920. However, it should be noted that the row 930 may be closer to the left side.

In a third example, FIG. 9c shows a fourth pin configuration 940 according to an exemplary embodiment of the present invention. The configuration 940 also includes two rows 945, 950. Similar to the configuration 920 of FIG. 9b, the two rows 945, 950 of configuration 940 are aligned at an angle. However, this exemplary embodiment further shows that the two rows 945, 950 do not include the same number of pins. Specifically, the row 945 comprises seven pins while the row 950 comprises six pins. It should be noted that the rows may include fewer or more pins depending on the auxiliary device that is attached, the port (e.g., port 160, 170) to which the configuration is inserted, etc.

In a fourth example, FIG. 9d shows a fifth pin configuration 960 according to an exemplary embodiment of the present invention. Similar to the configurations 920 of FIG. 9b and configuration 940 of FIG. 9c, the configuration 960 includes rows that are aligned at an angle. However, in contrast to the previous examples, the configuration 960 includes three rows 965, 970, 975. Configuration 960 also includes the feature of configuration 940 (i.e., different number of pins in a given row). As illustrated, rows 965, 975 are aligned perpendicularly, but the rows 965, 975 may also be aligned at an angle.

In a fifth example, FIG. 9e shows a sixth pin configuration 980 according to an exemplary embodiment of the present invention. The rows 985, 990, 995 are arranged similarly to the configuration 960 (i.e., three rows aligned at an angle with the first and third row aligned perpendicularly). However, configuration 980 includes angled rows (i.e., non-linear rows).

It should be noted that the above described examples are exemplary only and the pin configuration may include further embodiments not shown. In addition, any one of the above described examples may also include the features of the other examples. For example, the staggered pattern of configuration 905 may be included in any of the other configurations 920, 940, 960, 980.

FIGS. 7a-b show perspective views of a first plug 700 and a second plug 750 for the connector of FIG. 1. The first plug 700 and the second plug 750 may apply to both the AD connector 110 or the scanner connector 135. The first plug 700 includes a pin housing 705 and pins 710. The second plug 750 includes a pin housing 755 and pins 760. The pin housings 705, 755 may be manufactured in a similar fashion to the pin housing 605 of FIG. 6. The dimensions of the pin housings 705, 755 may also be the same as the pin housing 605. As will be discussed below, the dimensions of the pin housings may alter depending on the pins 710, 760. It should be noted that the pins 710, 760 may be, for example, spring pins or solid pins, as discussed above.

The first plug 700 includes the pins 710 that remain completely within the pin housing 705. The pins 710 remain completely within the pin housing 705 by making the exposed portions of the pins 710 shorter than the height of pin housing 705. As discussed above, such an embodiment prevents potential damage to the pins 710. The second plug 750 includes the pins 710 that are exposed beyond the pin housing 755. Assuming the pin housing 755 has like dimensions as the pin housing 705, then the pins 760 may be elongated to pass beyond the height of the pin housing 755. If the type of pin used for the pins 710, 760 are identical, the pins 760 may simply be exposed more than the pins 710 (e.g., a smaller portion of the pins of pins 760 remains in the electrical housing 615).

FIG. 8a shows a second perspective view of the port of the mobile terminal of FIG. 1. It should be noted that the second perspective view 800 may apply to both the ports 160, 170 of FIG. 1 and corresponds to the port 160 of FIG. 4c. FIG. 8a shows the port that is also illustrated in FIGS. 5a-d. Specifically, the port of FIG. 8a exhibits electrical contact points 810 that couple to the spring pins (e.g., pins 405, 410). The electrical contact points 810 are contained in a port body 805 (e.g., that extends out from the back wall 455 of the recess 450 as illustrated in FIG. 4c). The electrical contact points 810 are connected to leads 815 that may, for example, connect the electrical contact points 810 with a processor, a bus, or any other component in the mobile terminal 105. The leads 815 allow the processor to use connectivity data to determine the pin configuration of the further hardware device that is connected. Furthermore, the leads also provides the electrical connection between the mobile device and the further hardware device.

As was illustrated in FIGS. 5e-f, the ports may be corresponding pin holes that also exhibit varying lengths. FIGS. 8b-c show a third perspective view 825 and a fourth perspective view 850, respectively, of the port of the mobile terminal of FIG. 1. It should be noted that the third 825 and fourth 850 perspective views may apply to both the ports 160, 170 of FIG. 1 and corresponds to the port 160 of FIG. 4c. FIG. 8b shows the port that is also illustrated in FIGS. 5e-f. Specifically, the port of FIG. 8b exhibits pin holes that extend through the entire length of the port while the port of FIG. 8c exhibits pin holes that extend partially the length of the port. The lengths of the port are determined based on the pin lengths, as will be discussed below.

The port of FIG. 8b includes a port body 830, pin holes 835, and a pin sensor 840 while the port of FIG. 8b includes a port body 855, pin holes 860, and pin sensor 865. The port bodies 830, 855 may be manufactured using, for example, rigid plastics (similar to the materials used for the pin housings 705, 755 of FIGS. 7a-b). The port bodies 830, 855 may serve to provide a holding area when the pins are inserted into the port. The pin holes 835, 860 are the spaces to which the pins are inserted. Specifically, in the exemplary embodiments, the pin holes 835, 860 are formed from a portion of the port body 830 and a portion of the pin sensor 840. The number of pin holes correspond to the maximum number of pins that may be present on the plug of the connector. In the exemplary embodiments, there are twelve pin holes to correspond to the illustrative connectors of FIGS. 4a-b, 7a-b. As discussed above, it should again be noted that the use of twelve pin holes in two linear rows arranged so that the columns are perpendicular is only exemplary and the configurations may correspond to pin formations such as those illustrated in FIGS. 9a-e. The pin sensors 840, 865 correspond to the pin sensor 420 of FIGS. 5e-b. The locations and the relationships to the pin hole lengths for the pin sensors 840, 865 will be discussed below.

In the exemplary embodiment of FIG. 8b, the pin holes 835 exhibit pin hole lengths that extend the entire length of the port. That is, pins (e.g., pins 710, 760) that are inserted into the pin holes 835 traverse the entire length of the corresponding pin hole. Subsequently, the pins would extend beyond the port. For example, the pins 760 may be used with the pin holes 835. The pins would pass the pin sensor 840 so long as the pin sensor 840 is disposed within the port that spans a longitudinal cross-sectional area. It should be noted that since the pins extend beyond the port, the pin sensor 840 may be located anywhere in the port. For example, as illustrated, the pin sensor 840 is located just after the port body 830 towards the interior of the mobile terminal. The pin sensor 840 may include sensitive electronics so a further position from the exterior may be desired. Once the pins extend through the port, electronic components of the mobile terminal may be incorporated for transmission of corresponding data of the auxiliary device (i.e., further component). It should be noted that the electronic components of the mobile terminal may also be within the port body 830, within the pin sensor 840, etc.

In the exemplary embodiment of FIG. 8c, the pin holes 860 exhibit pin hole lengths that extend partially the length of the port. That is, pins that are inserted into the pin holes 860 traverse only the length of the pin hole (in contrast to through the entire port body). Therefore, the pins would not extend beyond the port. For example, the pins 710 may be used with the pin holes 860. Because the auxiliary device recognition is accomplished using the pin sensor 865, the pins pass the pin sensor 865 that is disposed within the port that spans a longitudinal cross-sectional area. It should be noted that since the pins only extend partially the length of the port body 855, the pin sensor 865 is located within the port body 855. For example, the pin sensor 865 may be located at the midpoint of the length of the pin holes 860. Once the pins are inserted into the pin holes 860, electronic components of the mobile terminal may be incorporated within the port body 855 for transmission of corresponding data of the auxiliary device (i.e., further component). It should be noted that the electronic components of the mobile terminal may also be, for example, connected to the inner ends of the pin holes where the pins ends will be located upon insertion.

As discussed above with reference to FIG. 1, the ports 160, 170 are located on a right side and a left side, respectively, of the mobile terminal 105. Also, as discussed above, the ports 160, 170 are identical in configuration. That is, the physical properties of the ports 160, 170 are the same. Those skilled in the art will understand that as long as the configuration of the connector (e.g., AD connector 110, scanner connector 135) corresponds to the configuration of the port, then the further hardware device may be connected to the mobile terminal 105. Thus, the port that receives the connector of the further hardware device is independent of the type of the further hardware device. That is, any connector with the corresponding configuration is connectable to the mobile terminal 105 using any port. The user is free to connect the further hardware device in a manner that is most comfortable for that user. A user may be required to first install the further hardware device so that the connectivity data of a specific pin configuration may be recognized or so that the pin sensor 420 recognizes the pin configuration.

The identical configurations of the ports 160, 170 also eliminates the crossing of wires and/or other encumbrances so that the most convenient usage of the mobile terminal 105 with the further hardware may be had. Furthermore, those skilled in the art will understand that the mobile terminal 105 may be expensive. Therefore, there may be multiple users of the same mobile terminal 105. Each user is likely to feel more comfortable with a different orientation of the mobile terminal 105 with the further hardware. The identical ports 160, 170 with corresponding connectors allow each user to freely orient the mobile terminal 105 as desired.

In the above description, the exemplary embodiments showed the connectors of the further hardware devices to include male pin connectors and the connectors of the ports of the mobile device to include female pin connectors. Those skilled in the art will understand that any type of connectors may be used. For example, the further hardware device connector may include female pin connectors and the port connectors of the mobile device may include male pin connectors. The male pins may be solid or hollow. The connectors may not be pins, but may be spring contacts, leads, conducting plates, strip connectors, etc.

It should also be noted that as described above, the exemplary embodiments allow any further hardware device to be connected to any port of the mobile device. The mobile device may then detect the type of hardware device that is connected to the ports. The mobile device may further include a configuration element or module that may configure the mobile device to operate with the attached further hardware device. The configuration module may be a hardware component, a software component or a combination thereof. In one example, the configuration module is a set of configuration instructions that are executed by a processor of the mobile device based on the type of detected further hardware devices.

The configuration may include, for example, selecting the proper driver for the attached device. It may also include, for example, configuring other components of the mobile device for operation based on the attached hardware device such as preparing the processor to receive a specific type of data, e.g., data from a scanner, data from an RFID reader, etc.

The configuration may also determine for example, if an integral display of the mobile device should be configured for left handed or right handed operation. For example, if the mobile device determines that a scanner is connected to a first port and an audio device is connected to a second port, this may indicate that the wearable mobile device has been attached to a right arm of the user. The configuration module may then configure the integral display of the mobile device for right-handed operation. However, if the connections were opposite, the configuration module may configure the device for left-handed operation. Other types of configuration settings that may be set based on the detection of the further hardware device will be apparent to those skilled in the art.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A mobile device, comprising:
a multi-contact connector configured to couple to a further connector of one of a plurality of auxiliary devices, the further connector having a preset configuration of contact points for each type of the auxiliary devices; and
a detection module determining a type of the one of the plurality of auxiliary devices as a function of the preset configuration of contact points.

2. The mobile device of claim 1, wherein the detection module determines the type of the one of the plurality of auxiliary devices based on at least one of a number of contact points and a position of contact points of the preset configuration.

3. The mobile device of claim 1, further comprising:
a second multi-contact connector configured to couple to the further connector.

4. The mobile device of claim 3, wherein the first and second multi-contact connectors are disposed on opposing sides of the mobile device.

5. The mobile device of claim 1, wherein the auxiliary device is one of a scanner, an audio device, a disk drive, an imaging device, an RFID reader, a display device, an input device and an input/output device.

6. The mobile device of claim 1, further comprising:
a locking mechanism locking the further connector into the multi-contact connector.

7. The mobile device of claim 1, wherein the multi-contact connector comprises a set of female pins and the contact points comprise a set of male pins having the preset configuration, wherein, when in an operative position, the set of male pins is inserted into the set of female pins.

8. The mobile device of claim 1, wherein the detection module is disposed at one of an outer edge of the multi-contact connector, within the multi-contact connector, and on an inner edge of the multi-contact connector.

9. The mobile device of claim 1, wherein the detection module is disposed on a longitudinal cross-sectional area of the multi-contact connector.

10. The mobile device of claim 1, wherein the detection module includes one of a pin sensor and an optical sensor.

11. The mobile device of claim 1, wherein the detection module includes a processor.

12. The mobile device of claim 1, wherein the preset configuration of contact points for a first auxiliary device is complimentary with the preset configuration of contact points for a second auxiliary device.

13. The mobile device of claim 1, further comprising:
a processor receiving the determination of the type of the one of the plurality of auxiliary devices and configuring the mobile device for operation with the type of the one of the plurality of auxiliary devices.

14. The mobile device of claim 1, further comprising:
a housing including a recess, wherein the multi-contact connector is located within the recess.

15. A mobile device, comprising:
a first multi-contact connector configured to couple to a first further connector of a first auxiliary device, the first further connector having a first configuration of contact points;
a second multi-contact connector configured to couple to a second further connector of a second auxiliary device, the second further connector having a second configuration of contact points, wherein the first multi-contact point connector is further configured to couple to the second further connector and the second multi-contact connector is further configured to couple to the first further connector; and
a detection module determining a corresponding type of the first and second auxiliary device based on the first and second configurations of contact points.

16. The device of claim 15, wherein the detection module determines the corresponding type of the first and second auxiliary devices based on at least one of a number of contact points and a position of contact points of the first and second configurations.

17. The device of claim 15, wherein the detection module is a plurality of detection modules, each of the multi-contact connectors having a corresponding detection module.

18. The device of claim 15, further comprising:
a housing, wherein the first multi-contact connector is at least partially situated within a first location of the housing and the second multi-contact connector is at least partially situated within a second location of the housing.

19. The device of claim 18, wherein the first location is a first side of the housing and the second location is an opposing side of the housing.

20. The device of claim 18, wherein the housing includes a first recess at the first location and a second recess at the second location.

21. The device of claim 15, further comprising:
a configuration module configuring the mobile device to operate with the corresponding type of the one of the determined first and second auxiliary devices.

22. A connector for connecting an auxiliary device to a mobile device, comprising:
a plug housing; and
a plurality of contact points disposed at least partially within the plug housing and having a preset configuration so that when the connector is coupled to a port of the mobile device, the plurality of contact points are aligned with corresponding contact points of the port, the preset configuration identifying to the mobile device a type of the auxiliary device.

23. The connector of claim 22, wherein the auxiliary device is one of a scanner, an audio device, a disk drive, an imaging device, an RFID reader, a display device, an input device and an input/output device.

24. The connector of claim 22, further comprising:
a locking mechanism locking the connector into the mobile terminal.

25. The connector of claim 22, wherein the plurality of contact points comprise one of male pins, female pins, spring contacts, leads, conducting plates, and strip connectors.

26. The connector of claim 22, further comprising:
a break away point.

27. The connector of claim 22, wherein the plurality of contact points are arranged to include one of a single row of contact points, two rows of contact points, three rows of contact points, four rows of contact points and five rows of contact points.

28. The connector of claim 22, wherein the plurality of contact points one of extend beyond the plug housing, extend to a plane created by an edge of the plug housing and do not extend to the plane created by the edge of the plug housing.

29. The connector of claim 22, wherein the connector is configured to couple to a plurality of ports on the mobile device.

30. The connector of claim 22, wherein the plurality of contact points are arranged in one of a random pattern, a staggered pattern and a uniform pattern.

31. The connector of claim 22, wherein the preset configuration identifies the type of the auxiliary device based on at least one of a number of the contact points and a position of the contact points.

32. The connector of claim 22, wherein the plug housing includes a portion which occupies a recess at least partially surrounding the port, wherein the connector is coupled to the port.

33. A port of a mobile device, comprising:
a connector including a plurality of contact points configured to couple to a further connector of one of a plurality of auxiliary devices, the further connector having a preset configuration of further contact points for each type of the auxiliary devices; and
a detection module detecting the preset configuration of the further contact points when the further connector is coupled to the connector to identify the type of the auxiliary device.

34. The port of claim 33, wherein the detection module identifies the type of the auxiliary device based on at least one of a number of the contact points and a position of the contact points.

35. The port of claim 33, wherein the plurality of contact points plurality of contact points comprise one of male pins, female pins, spring contacts, leads, conducting plates, and strip connectors

36. The port of claim 33, wherein the plurality of contact points are arranged in a single row of contact points.

37. The port of claim 33, wherein the plurality of contact points are arranged in a plurality of rows.

38. The port of claim 37, wherein each of the rows has an equal number of contact points.

39. The port of claim 37, wherein at least one of the rows has a different number of contact points from another one of the rows.

40. The port of claim 37, wherein one of the rows is offset from an adjacent row so that a bisecting line of any of the contact points in the one of the rows is not a bisecting line of any of the contact points in the adjacent row.

41. The port of claim 33, wherein the connector has a substantially rectangular shape.

42. The port of claim 33, wherein the detection module is one of a pin sensor and an optical sensor.

43. The port of claim 33, further comprising:
a locking mechanism locking the further connector to the connector.

44. The port of claim 33, wherein the port extends from a back wall of a recess of a housing of the mobile device.

45. The port of claim 44, wherein no sidewalls of the recess contact the port.

46. A method, comprising:
detecting a preset configuration of contact points connected to a port of a mobile device, wherein the contact points are included in a connector for an auxiliary device;
determining a type of the auxiliary device based on the preset configuration; and
configuring the mobile device to operate with the type of the auxiliary device.

47. The method of claim 46, wherein the detecting includes detecting at least one of the number of contact points and the position of the contact points of the preset configuration.

48. The method of claim 47, wherein the determining is based on the at least one of the number of contact points and the position of the contact points of the preset configuration.

49. The method of claim 46, further comprising:
detecting a preset configuration of contact points connected to a second port of the mobile device, wherein the contact points are included in a connector for a second auxiliary device;
determining a type of the second auxiliary device based on the preset configuration; and
configuring the mobile device to operate with the type of the second auxiliary device.
